(19) United States
(12) Patent Application Publication
(10) Pub. No.: US 2018/0220667 A1
(43) Pub. Date: Aug. 9, 2018

(54) READY-TO-DRINK BEVERAGES WITH IMPROVED TEXTURE BY CONTROLLED PROTEIN AGGREGATION

(71) Applicant: NESTEC S.A., Vavey (CH)

(72) Inventors: Alexander A. Sher, Dublin, OH (US); Virginie Kapchie, Dublin, OH (US); Veena Prabhakar, Dublin, OH (US); Madansinh Vaghela, Mancedonia, OH (US); Phillippe Rousset, Dublin, OH (US)

(21) Appl. No.: 15/749,559

(22) PCT Filed: Aug. 3, 2016
(86) PCT No.: PCT/EP2016/068486

§ 371 Date: Feb. 1, 2018

Related U.S. Application Data
(60) Provisional application No. 62/202,002, filed on Aug. 6, 2015.

(51) Int. Cl. A23C 9/15; A23C 9/154; A23L 27/28

(52) U.S. Cl. CPC A23C 9/1512; A23C 9/1542; A23L 27/28; A23V 2002/00; A23V 2200/06; A23V 2200/212; A23V 2300/26; A23V 2250/0628; A23V 2250/1578; A23V 2250/54246; A23V 2250/54252; A23V 2250/51082; A23V 2250/042

(57) ABSTRACT

The present invention relates to ready-to-drink beverage products. In particular, the invention is concerned with a protein system induced by controlled aggregation of milk proteins which imparts outstanding sensory attributes and improved physical stability of the beverage product, in particular when containing low fat and/or low sugar. A method of producing such beverage and the products obtainable from the method are also part of the present invention.

### FIELD OF THE INVENTION

The present disclosure generally relates to milk containing beverages with improved texture/mouthfeel by controlled protein aggregation at ultra-high temperature (UHT) treatment conditions using all-in-one process. More specifically, the present disclosure relates to ready to drink (“RTD”) reduced fat and/or sugar beverages containing milk and a hydrocolloid/based stabilizing system and also relates to methods for making the same.

### BACKGROUND OF THE INVENTION

Fat and sugar reductions are the two main choices of a health-conscious consumer.

Such a reduction does have an impact on taste and texture/mouthfeel. Thus, with regard to fat reduction, by evolving from using whole milk to reduced fat milk creaminess perception of the beverage is negatively affected. Today's consumer is demanding good value low calorie product without a compromise in taste and texture. Such a solution to the problem is a challenge.

Another problem faced with reduction of fat and/or sugar in RTD beverages is the physical destabilization, e.g. phase separation, syneresis, layering, creaming and/or sedimentation. Additional challenge is an undesirable increase of beverage age gelation issues during shelf life storage.

Thus, the objective of the invention is to achieve both the requirements below:

to develop aseptic low fat/low sugar (NF) RTD beverage with unique indulgent texture towards full fat/full sugar products using simplified all-in-one process of making protein aggregates at UHT conditions;

to provide good product physical stability over product shelf-life.

The majority of existing solutions with indulgent mouthfeel have high calorie. There are limited solutions for low fat/low sugar shelf stable RTD beverages which have texture/mouthfeel similar to that of high fat/high sugar beverages. On the other hand, some existing low calories versions are lacking in thick, creamy texture. Some RTD solutions are only for the refrigerated beverages.

Therefore, there is a need for a simplified all-in-one method to improve texture/mouthfeel of reduced fat/reduced sugar RTD chocolate beverages without compromising product physical stability during long shelf-life (6-month or more) at ambient temperatures.

### SUMMARY OF THE INVENTION

The present disclosure provides a flavored ready-to-drink (RTD) milk beverage and also provides methods for making such beverages. The ready-to-drink milk beverages can have reduced sugar and/or fat, can be ESL or aseptic, and can have a pleasant mouthfeel. The ready-to-drink milk beverages can have an improved physico-chemical stability during storage, e.g., stable for at least 7 months at refrigeration for extended shelf life (ESL) products; and 7 months at refrigeration, 7 months at 20° C., 4 months ambient temperatures at 30° C. and 2 months at 38° C. for aseptic products. The milk beverage eliminates gelation and overcomes problems with phase separation/instability issues during different storage conditions over the full life of the milk beverages.

The object of the present invention relates to solving the problems of:
(i) lack of texture/mouthfeel in reduced fat/reduced sugar RTD and;
(ii) physical instability issues of reduced fat/reduced sugar RTD.

The benefits of the present invention includes the following:

Significantly simplified process in aseptic dairy RTD beverages;

Ability to produce low calories aseptic RTD beverages with indulgent creamy, thick product texture/mouthfeel;

Enable the product to keep the unique texture and taste during its shelf life;

Provide enhanced shelf-life physical stability without syneresis, sedimentation, creaming; and

Avoid gelation issues.

Thus, the present invention solves the foregoing problems by providing a stable beverage having enhanced or improved organoleptic properties.

Provided is composition of aseptic shelf-stable liquid RTD beverage, formed by the interaction of milk fat, milk proteins (such as casein and whey), carbohydrate(s), and optionally sweetener(s), flavor(s), and stabilized by the use of complex systems containing the combinations of hydrocolloids.

The present invention provides indulgent, creamy texture/mouthfeel similar to that of 2% milk fat/full sugar beverage but at lower calorie level (reduced fat and/or sugar) and simplified all-in-one method to make the same.

In a first aspect, the invention relates to a ready to RTD beverage comprising:

A ready to drink (RTD) beverage product comprising:
milk comprising casein and whey proteins wherein ratio between casein and whey protein ranges from 80:20 to 60:40 and wherein milk comprises 0.5 to 4 wt/wt % milk fat;
added carbohydrate less than 5 wt/wt %;
an acidifier; and
a stabilizing system comprising a co-processed microcrystalline cellulose (MCC), carboxymethyl cellulose (CMC) in the range of about 0.05-0.18 wt/wt %, and lambdacarrageenan in the range of about 0.01-0.10 wt/wt % and high acyl gellan gum in the range of 0.01 to 0.025 wt/wt %;
wherein the beverage comprises casein-whey protein aggregates having a volume based mean diameter value D [4,3] ranging from 7 to 15 μm as measured by laser diffraction.

The aseptic RTD beverages are shelf-stable at 4° C. for at least 7 months, at 20° C. for at least 6 months, for at least 4 months at 30° C., and for at least 2 month at 38° C. The extended shelf life (ESL) RTD beverages are shelf-stable at 4° C. for at least 6 months.

The products of the invention present excellent organoleptic properties, in particular in terms of texture and mouthfeel even when very low levels of fat or sugar are used. Besides, the products of the invention show good stability over extended product shelf-life.

Thus, using the novel approach of combining 1-step protein aggregation with new hydrocolloid system, the invention not only improves product texture/mouthfeel but also overcomes physical instability issues during product shelf-life.

Another aspect of the present invention relates to a method of producing a RTD beverage comprising the steps of:

Mixing ingredients as defined above;

adjusting pH to 6.25 to 6.4 using the acidifier;

Homogenizing the mixture at total pressure ranging from 135-300 bars and temperature ranging from 65-80° C.;
Sterilizing at UHT conditions at 136-150° C. for 3-30 seconds

Cooling the obtained beverage base product to 25° C. or below; and

Filling aseptically for UHT beverages in aseptic containers.

### BRIEF DESCRIPTION OF FIGURES

FIG. 1. Visual evaluation of beverages prepared with controlled protein aggregation using old (see example 3 below) and new (see example 1 and 5) hydrocolloid systems.

FIG. 2. Gelation of 1% milkfat RTD Chocolate beverage with and without (reference) controlled protein aggregation

FIG. 3. Texture sensory score of 1% milkfat RTD Chocolate beverage with and without (reference) controlled protein aggregation

### DETAILED DESCRIPTION OF THE INVENTION

In the following description, the % values are in wt/wt % unless otherwise specified.

The present invention pertains to protein containing beverage, more particularly to RTD beverage. The present invention addresses the following issues:
Significantly improved product texture/mouthfeel of reduced fat/reduced sugar RTD beverages
Developed beverage with no physical instability issues of reduced fat/reduced sugar RTD beverages
Provided stable RTD beverages with unique texture and taste during product shelf life

There are no current solutions using controlled protein aggregation for shelf stable RTD beverages with low sugar/fat content which have a mouthfeel similar to full sugar beverages and are shelf-stable during the life of the beverage.

Advantageously and unexpectedly, a unique combination of the hydrocolloid stabilizing system ingredients, specific ratio of casein to whey proteins, specific combination of pH, heat and holding time were found to improve beverage texture/mouthfeel and provide a pleasant, smooth creamy taste of RTD beverage. In addition, the desired texture improvement and desired product shelf life stability were found only when the homogenization was done prior to applying UHT treatment at the specific combination of pH, temperature and holding time.

As a result, the reduced fat/reduced sugar RTD beverage has improved texture and good physico-chemical stability during shelf life. The novel hydrocolloid texturizing/stabilizing system includes stabilizing system comprising a co-processed microcrystalline cellulose (MCC), carboxymethyl cellulose (CMC) in the range of about 0.05-0.18 wt/wt %, and lambda carrageenan in the range of about 0.01-0.10 wt/wt % and high acyl gellan gum in the range of 0.01 to 0.025 wt/wt %.

In one embodiment of the present invention, the term “milk” constitutes milk fat in the range of 0.5 to 4 wt/wt %. In another embodiment the milk fat may range from 0.5 to 1.5 wt/wt %.

In one embodiment of the present invention, the RTD beverage comprises casein-whey protein aggregates having a volume based mean diameter value D [4,3] ranging from 7 to 15 μm as measured by laser diffraction. We have surprisingly found that particle size of protein aggregates outside the range leads to undesired characteristics. For instance if the mean diameter value D [4,3] exceeds 15 μm, sandiness occurs thus negatively affecting mouthfeel. On the other hand, if the mean diameter value D [4,3] is below 7 μm, texture is not significantly improved.

If we use the hydrocolloids outside the above ranges, gelation or phase separation issues (e.g. serum, sedimentation) will occur (examples within and outside of the ranges are provided below).

In one embodiment of the present invention, the carrageenan is present in lamda form and ranges from 0.01 to about 0.10 wt/wt % of the beverage. Other forms of carrageenan such as kappa and/or iota did not provide the required physical stability.
In one embodiment of the present invention, the stabilizing system comprises high acyl gellan gum in the range of 0.01 to 0.025 wt/wt %. We found that only highly acyl form of the gellan gum provides the required shelf-life stability.

In one embodiment of the present invention, the MCC and CMC are present in co-processed forms and wherein the amount ranges from about 0.05 to about 0.18 wt/wt %.

In one embodiment of the present invention, the acidifier comprises but not limited to lactic acid, glucono delta-lactone, phosphoric acid, ascorbic acid, acetic acid, citric acid, malic acid, hydrochloric acid, or combination of thereof.

The term “glucono delta-lactone” is a lactone (cyclic ester) of D-gluconic acid. Upon addition to water, glucono delta-lactone is partially hydrolysed to gluconic acid, with the balance between the lactone form and the acid form established at chemical equilibrium.

In one embodiment of the present invention, the RTD beverage further comprises calcium salts for calcium fortification.

In one embodiment of the present invention, the calcium salt comprises but not limited to calcium carbonate, calcium phosphate, calcium lactate-citrate, calcium citrate, or combination of thereof.

In an embodiment, the product may include a buffering agent. The buffering agent can be, for example, monophosphates, diphosphates, sodium mono- and bicarbonates, potassium mono- and bicarbonates or a combination thereof. More specifically, non-limiting examples of suitable buffers are salts such as potassium phosphate, potassium phosphate, potassium bicarbonate, potassium citrate, sodium bicarbonate, sodium citrate, sodium phosphate, disodium phosphate. The buffer can be present in an amount of about 0.05 to about 0.5% of the total weight of the product.

In an embodiment, the product includes addition of sugar, wherein sugar is sucrose up to about 5 wt/wt %.

In an embodiment, the product includes addition of natural and/or artificial sweeteners.

In an embodiment, the product includes addition of cocoa powder, flavors such as chocolate, vanilla, banana, strawberry, raspberry, milk or combination of thereof.

### Liquid Beverage Composition and Product

A beverage composition according to the invention comprises the RTD beverage as described in the present invention and may be any beverage composition, meant to be consumed by a human or animal, such as e.g. a beverage, e.g. a coffee beverage, a cocoa or chocolate beverage, a malted beverage, a fruit or juice beverage, or a milk based beverage; a performance nutrition product, a medical nutrition product; a milk product, e.g. a milk drink, a product for improving mental performance or preventing mental decline, or a skin improving product.

### Beverage or Beverage Composition

A beverage according to the invention comprises the RTD beverage as described in the present invention and may e.g. be in the form of a ready-to-drink beverage. By a ready-to-drink beverage is meant a beverage in liquid form ready to be consumed without further addition of liquid. A beverage according to the invention may comprise any other suitable ingredients known in the art for producing a beverage, such as e.g. sweeteners, e.g. sugar, such as invert sugar, sucrose, fructose, glucose, or any mixture thereof, natural or artificial sweetener; aromas and flavors, e.g. fruit, cola, coffee, or tea aroma and/or flavor; fruit or vegetable juice or puree; milk; stabilizers; natural or artificial color; preservatives; antioxidants, or combination of thereof.

A ready-to-drink beverage may be subjected to a heat treatment to increase the shelf life or the product, UHT (Ultra High Temperature) treatment, HTST (High Temperature Short Time) pasteurization, batch pasteurization, or hot fill.

Milk protein containing liquid beverages are beverages or beverage concentrates containing milk (e.g. fluid, fat-removed, lactose-removed, powder, concentrate, fractionated) or the proteins obtained, whether native or modified, from milk, or a mixture thereof.

According to a particular embodiment, the pH ranging from 6.25 to 6.4 measured at refrigeration temperature after adding all the ingredients is controlled by the presence of an acidic component preferably selected but not limited from the group consisting of lactic acid, glucono delta-lactone, phosphoric acid, ascorbic acid, acetic acid, citric acid, malic acid, hydrochloric acid, molasses, fruit derived acids and fermentation derived acids.

According to a particular embodiment, the product according to the invention comprises about 0.5 to about 1.5 wt/wt % milk fat, up to about 3.5 wt/wt % protein and sweetening agent, e.g. sugar from about 0 to 5 wt/wt %.

By “sweetening agent” it is to be understood an ingredient or mixture of ingredients which imparts sweetness to the final product. These include natural sugars like cane sugar, beet sugar, molasses, other plant derived nutritive and non-nutritive sweeteners, and chemically synthesized non-nutritive high intensity sweeteners.

The reduction of fat in beverages without compromising the indulgent quality of the product is one of the main challenges faced by the industry. The present invention is overcoming this issue in providing low fat products with similar texture and sensory attributes than those having higher fat contents in terms of texture/mouthfeel.

The products include a stabilizer system.

A “stabilizer system” is to be understood as an ingredient or a mixture of ingredients which contributes to the stability of the beverage product with respect to shelf life. Thus, the stabilizer system may comprise any ingredients which provide physical stability to the beverage.

The product may additionally comprise flavors or colorants. These are used in conventional amounts which can be optimized by routine testing for any particular product formulation.

It has been surprisingly found out that the presence of this controlled protein aggregation system in a beverage according to the invention improves the sensory profile of the product and in particular that it enhances considerably the smooth and creamy texture of said beverage that contains this system.

It is a common knowledge that addition of proteins to the beverage (e.g. whey) will lead to enhanced mouthfeel. It was surprisingly found that when controlled protein aggregation is created, addition of whey proteins significantly improves (much higher compared to that without protein aggregation) product mouthfeel only at the specific casein to whey ratio, i.e. wherein ratio between casein and whey proteins is from about 80:20 to about 60:40, probably due to the synergy within new structure formation. Addition of whey proteins above 60:40 ratio resulted in decrease of beverage mouthfeel.

The present invention is a directed controlled protein aggregation system produced by an acidic component and specific heat treatment conditions, i.e. specific combination pH, temperature and holding time in proteins such as milk proteins, which has shown to considerably improve the mouthfeel and creaminess of the beverage of the invention.

Furthermore, the product of the invention has proven to be particularly stable, both when refrigerated as well as when kept at ambient or higher temperatures for human consumption.

The invention relates in a further aspect to the use of a controlled protein aggregation system including casein and whey proteins for manufacturing a beverage with a heat treatment at pH between 6.25 and 6.4.

The heating temperature ranges from 136-150° C. and holding for 3-30 seconds.

Such a system offers the unexpected advantage that it can confer to the beverage product exceptional sensory attributes with good stability while minimizing the fat and sugar content.

The homogenization step of the present invention may be performed in one or two steps. The two step homogenization approach comprises the first step wherein liquid mixture is exposed to a pressure in the range of 100 to 250 bars and followed by a second step having pressure in the range of 35 to 50 bars.

The process of the invention has surprisingly proven to enhance the textural experience of beverages according to the invention even at lower fat and/or sugar contents. The applicant has discovered that combination of the four parameters, i.e. the pH, specific pre-heat treatment and holding time of the composition and specific casein to whey protein ratio before sterilization results in a product with smooth, creamy texture and superior shelf life stability when compared to typical beverage products. In addition, it is critical to have a homogenization step before the specific heat treatment.

The method of the invention lends itself to the manufacture of beverages according to the invention which are shelf-life stable at the necessary storage temperatures and have superior organoleptic and textural properties.

### EXAMPLES

The present invention is illustrated further herein by the following non-limiting examples.

In this and in the all other examples of the invention, concentrations of ingredients are given as wt/wt % based on the whole product formulation.

1% milkfat milk was used in preparation of all samples described in the examples below.

Particle size distribution was determined by using a laser light scattering Mastersizer 3000 MA(Malvern Instrument) equipped with Hydro 2000G dispersion unit. The weighted volume mean D [4,3] were reported.

### Example 1

### Process Without Controlled Protein Aggregation (CPA)

The RTD beverages can be made by the following process:
Hydration (e.g., wetting) of cocoa powder for 45 minutes at 90° C. to form the cocoa slurry.
A co-processed microcrystalline cellulose (MCC) and carboxymethyl cellulose (CMC) were dry blended with high acyl gellan gum, carrageenan and sucrose and then were added under high agitation to a separate tank containing fluid milk
Addition under agitation of the cocoa slurry to the fluid milk tank containing hydrocolloids
Addition under agitation of rest of ingredients such as sweetener, other flavors, and minerals.
Aseptic homogenization at 135/35 bars at 70° C.
Subjection of the beverage to ultra-high temperature (“UHT”) heat treatment at about 141° C. for about 3 seconds
The aseptic homogenization is followed by cooling below 25° C. and aseptic filling of the RTD beverage into a suitable aseptic container, e.g. PET bottles, Tetra Pak®, jars, jugs or pouches.

### Example 2

### Process with CPA

The RTD beverage with controlled protein aggregation was prepared as in Example 1, but with pH adjusting by adding lactic acid before aseptic homogenization to obtain the desired pH of about 6.3 (measured at 4° C.).

### Example 3

### Process with CPA Using Old Hydrocolloid System

The RTD beverage with controlled protein aggregation was prepared as in Example 2 process, using 90 kg of 1% fat milk, 450 g of nonfat dry milk, 160 g of whey proteins, 135 g of co-processed microcrystalline cellulose (MCC) and carboxymethyl cellulose (CMC), 35 g of carrageenan, 4.2 kg sugar, 500 g of cocoa, 70 g of 80% lactic acid, 150 g of calcium carbonate and water necessary to reach 100 kg of the final beverage.

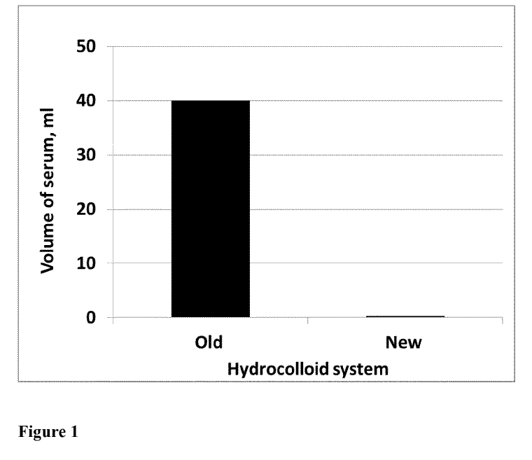

Beverage physico-chemical properties were evaluated and sensory characteristics were judged by trained sensory panelists. Phase separation such as syneresis was found in sample prepared during shelf-life. Syneresis was measured as serum separated from 500 ml of beverages stored in PET bottle (FIG. 1). The syneresis was more severe at higher storage temperatures.

A volume based mean diameter value D [4,3] determined by laser diffraction was about 45 μm.

### Example 4

### Reference (Process Without CPA)

The RTD beverage with controlled protein aggregation was prepared as in Example 2 process, using 90 kg of 1% fat milk, 450 g of nonfat dry milk, 160 g of whey proteins, 135 g of co-processed microcrystalline cellulose (MCC) and carboxymethyl cellulose (CMC), 35 g of carrageenan, 20 g of high acyl gellan gum, 4.2 kg sugar, 500 g of cocoa, 150 g of calcium carbonate and water necessary to reach 100 kg of the final beverage.

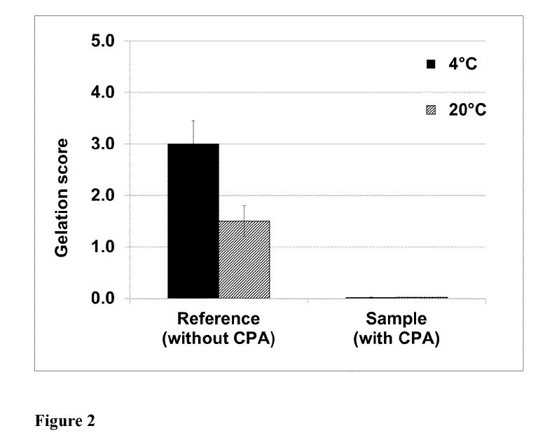

Beverage physico-chemical properties were evaluated and sensory characteristics were judged by trained sensory panelists. Gelation issues were found during shelf life (FIG. 2).

### Example 5

### Sample (Process with CPA)

The RTD beverage was prepared as in Example 4 but with addition of 70 g of lactic acid before aseptic homogenization.

Beverage physico-chemical properties were evaluated and sensory characteristics were judged by trained sensory panelists.

No phase separation including syneresis, gelation, marbling and no sedimentation were found in sample during shelf-life (FIGS. 1 and 2).

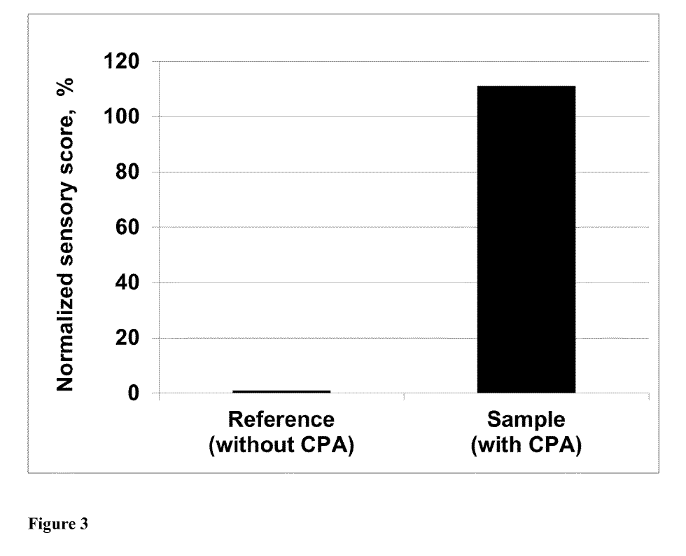

It was found that the RTD chocolate drink has homogeneous appearance during shelf-life and significantly improved texture/mouthfeel. Results of sensory texture evaluation as compared to the target containing 2% milk fat (100% score) are shown in FIG. 3.

A volume based mean diameter value D [4,3] determined by laser diffraction was about 10 μm.

### Example 6

The RTD beverage was prepared as in Example 5 but with addition 30 g of co-processed microcrystalline cellulose (MCC) and carboxymethyl cellulose (CMC).

Beverage physico-chemical properties were evaluated and sensory characteristics were judged by trained sensory panelists. Phase separation including marbling and sedimentation were found in the beverage during shelf-life.

### Example 7

The RTD beverage was prepared as in Example 5 but with addition 200 g of co-processed microcrystalline cellulose (MCC) and carboxymethyl cellulose (CMC).

Beverage physico-chemical properties were evaluated and sensory characteristics were judged by trained sensory panelists. Phase separation including syneresis and gelation were found in the beverage during shelf-life.

### Example 8

The RTD beverage was prepared as in Example 5 but with addition 5 g of high acyl gellan gum.

Beverage physico-chemical properties were evaluated and sensory characteristics were judged by trained sensory panelists. Phase separation including marbling and sedimentation were found in the beverage during shelf-life.

### Example 9

The RTD beverage was prepared as in Example 5 but with addition 30 g of high acyl gellan gum.

Beverage physico-chemical properties were evaluated and sensory characteristics were judged by trained sensory panelists. Phase separation including syneresis and gelation were found in the beverage during shelf-life.

### Example 10

The RTD beverage was prepared as in Example 5 but with addition of 5 g of carrageenan.

Beverage physico-chemical properties were evaluated and sensory characteristics were judged by trained sensory panelists. Phase separation including marbling and sedimentation were found in the beverage during shelf-life.

### Example 11

The RTD beverage was prepared as in Example 5 but with addition 120 g of carrageenan.

Beverage physico-chemical properties were evaluated and sensory characteristics were judged by trained sensory panelists. Phase separation including syneresis, marbling and gelation were found in the beverage during shelf-life.

1. A ready to drink (RTD) beverage product comprising:
milk comprising casein and whey proteins wherein ratio between casein and whey protein ranges from 80:20 to 60:40 and wherein milk comprises 0.5 to 4 wt/wt % milk fat;
added carbohydrate less than 5 wt/wt %;
an acidifier;
a stabilizing system comprising a co-processed microcrystalline cellulose (MCC), carboxymethyl cellulose in the range of about 0.05-0.18 wt/wt %, and lambda carrageenan in the range of about 0.01-0.10 wt/wt % and high acyl gellan gum in the range of 0.01 to 0.025 wt/wt %; and
the beverage comprises casein-whey protein aggregates having a volume based mean diameter value D [4,3] ranging from 7 to 15 μm as measured by laser diffraction.

2. The RTD beverage of claim 1 further comprises added whey proteins to achieve casein: whey ratio in range of 75:25 to 60:40.

3. The RTD beverage of claim 1, wherein the acidifier is selected from the group consisting of lactic acid, glucono delta-lactone, phosphoric acid, ascorbic acid, citric acid, malic acid and combinations thereof.

4. The RTD beverage of claim 1, wherein the acidifier is lactic acid.

5. The RTD beverage of claim 1 further comprises a component selected from the group consisting of calcium carbonate, calcium phosphate, calcium lactate-citrate, calcium citrate, and combinations thereof.

6. The RTD beverage of claim 1, wherein sugar is sucrose up to about 4.5 wt/wt %.

7. The RTD beverage of claim 1, wherein milk fat is 0.5 to 1.5 wt/wt %.

8. The RTD beverage of claim 1 further comprises flavor comprising fruit flavor or cocoa.

9. The RTD beverage of claim 1 comprising cocoa.

10. The RTD beverage of claim 1 further comprises a buffer selected from the group consisting of phosphate based buffers, carbonate based buffers, citrate based buffers and combinations thereof.

11. A method of producing a RTD beverage comprising the steps of:
mixing ingredients comprising milk comprising casein and whey proteins wherein ratio between casein and whey protein ranges from 80:20 to 60:40 and wherein milk comprises 0.5 to 4 wt/wt % milk fat; added carbohydrate less than 5 wt/wt %; an acidifier; a stabilizing system comprising a co-processed microcrystalline cellulose (MCC), carboxymethyl cellulose in the range of about 0.05-0.18 wt/wt %, and lambda carrageenan in the range of about 0.01-0.10 wt/wt % and high acyl gellan gum in the range of 0.01 to 0.025 wt/wt %; and the beverage comprises casein-whey protein aggregates having a volume based mean diameter value D [4,3] ranging from 7 to 15 μm as measured by laser diffraction;
adjusting pH to 6.25 to 6.4 using the acidifier;
homogenizing the mixture at total pressure ranging from 135-300 bars and temperature ranging from 65-80° C.;
sterilizing at UHT conditions at 136-150° C. for 3-30 seconds;
cooling the obtained beverage base product to 25° C. or below; and
filling aseptically UHT beverages in aseptic containers.

12. The process of claim 11, wherein the homogenization is in two steps comprising the first step wherein liquid mixture is exposed to a pressure in the range of 100 to 250 bars and followed by a second step having pressure in the range of 35 to 50 bars.
